(19) United States
(12) Patent Application Publication
(10) Pub. No.: US 2005/0112425 A1
(43) Pub. Date: May 26, 2005

(54) Fuel cell for hydrogen production, electricity generation and co-production

(75) Inventor: Michael S. Hsu, Lincoln, MA (US)

Correspondence Address: LAHIVE & COCKFIELD, LLP., 28 STATE STREET, BOSTON, MA, 02109, US

(73) Assignee: Ztek Corporation, Woburn, MA (US)

(21) Appl. No.: 10/938,145

(22) Filed: Sep. 10, 2004

Related U.S. Application Data
(60) Provisional application No. 60/509,209, filed on Oct. 7, 2003.

(51) Int. Cl. H01M 8/18; H01M 8/04; H01M 8/06

(52) U.S. Cl. 429/21; 429/22; 429/19; 429/17

(57) ABSTRACT

A hydrogen-electricity co-production (HECP) system utilizes a fuel cell to produce hydrogen, electricity, or a combination of both hydrogen and electricity. In a first mode, the fuel cell performs an electrochemical reaction by reacting a hydrogen-containing fuel with oxygen to produce electricity, water and heat. In a second mode, the fuel cell utilizes heat released by an electrochemical reaction of the fuel cell to reform a hydrogen-containing fuel to produce hydrogen rich gas. In a third mode, both hydrogen and electricity are co-produced by the fuel cell. The HECP system can control an amount of hydrogen and/or electricity produced and switch between modes by varying an electrical load on the system.

### REFERENCE TO RELATED APPLICATION

This application claims priority under 35 U.S.C. 119(e) to co-pending U.S. Provisional Application No. 60/509,209, entitled “Reversible Ionic Membrane Device with Autothermal Reforming for Combined Hydrogen and Power”, filed Oct. 7, 2003, the contents of which are incorporated herein by reference.

### FIELD OF THE INVENTION

The present invention relates to energy systems, and more specifically relates to high performance energy or power systems that employ electrochemical converters, such as fuel cells.

### BACKGROUND OF THE INVENTION

Conventional electrochemical converters, such as fuel cells, convert chemical energy derived from fuel stocks directly into electrical energy. The key components in an electrochemical converter are a series of electrolyte units having electrodes disposed over its surfaces, and a series of interconnectors disposed between the electrolyte units to provide serial electrical connections. The electrolyte units have fuel and oxidizer electrodes attached to opposite sides. Each electrolyte unit is an ionic conductor having low ionic resistance thereby allowing the transport of an ionic species from one electrode-electrolyte interface to the opposite electrode-electrolyte interface under typical converter operating conditions. Various electrolyte materials can be used, including, for example, zirconia stabilized with such compounds as magnesia, calcia or yttria are capable of satisfying the extremely high converter operating temperatures (typically around 1000° C.). The electrolyte material utilizes oxygen or oxygen-containing ions to carry electrical current. The electrolyte is typically not conductive to electrons which can cause a short-circuit of the converter. On the other hand, the interconnector is a good electronic conductor. The interaction of the reacting gas, electrode and electrolyte occurs at the electrode-electrolyte interface, which requires that the electrodes be sufficiently porous to admit the reacting gas species and to permit exit of product species.

During operation, typical fuel cells receive reactants, such as fuel and oxidizer, in respective manifolds, namely a fuel manifold and an oxidizer manifold. The fuel cell emits exhaust or resultants, such as spent fuel and the spent oxidizer, to the respective manifolds, namely the spent fuel manifold and the spent oxidizer manifold.

The fuel is distributed to the fuel electrode surface of the fuel cell units and the spent fuel is collected from downstream of the fuel electrode surface of the units. The oxidizer is distributed to the oxidizer electrode surface of the fuel cell units of the stack and the spent oxidizer is collected from downstream of the oxidizer electrode surface of the units. The spent fuel is the result of electrochemical reaction of fuel with oxidizer ionically conducted through the electrolyte.

In traditional fuel cell operation, the electrochemical reaction generates electrical voltage across the electrodes and electrical current flow from the oxidizer electrode to the fuel electrode through an external electrical load. It also produces heat according to electrochemical laws.

As is known in the art, the electrochemical converters can alternatively be operated in an electrolyzer mode, in which the electrochemical converter consumes electricity and input reactants to produce fuel.

When an electrochemical converter performs fuel-to-electricity conversion in a fuel cell mode, waste energy is generated and should be properly processed to maintain the proper operating temperature of the electrochemical device and to boost the overall efficiency of the power system. Conversely, when the device performs electricity-to-fuel conversion in the electrolyzer mode, the electrolyte must be provided with heat to maintain its reaction.

In the chemical industry, reformers typically reform hydrocarbon fuel into hydrogen-rich reformate. For example, a steam methane reformer can be used to produce hydrogen. In a steam methane reformer, hydrogen production is accomplished in several steps, including steam reforming, water gas shift reaction, and hydrogen purification. For steam reforming, hydrogen-rich gas is produced according to the following endothermic reaction:
CH₄+H₂O [symbol] CO+3H₂ ΔH=−206.16 kJ/mol CH₄

Consequently, heat needs to be provided to drive the reaction and is often provided by the combustion of a fraction of the incoming natural gas feedstock (up to 25%) or from burning waste gases, such as purge gas from a hydrogen purification system. Heat transfer to the reactants can be accomplished indirectly through a heat exchanger. Methane and steam react in catalyst filled tubes. Typically, the mass ratio of steam-to-carbon is about three or more to avoid “coking” or carbon build-up on the catalysts.

Another example of a conventional reformer suitable for reforming fuel is an autothermal reformer. In autothermal reforming, a hydrocarbon fuel, such as methane or a liquid fuel, is reacted with both steam and air to produce a hydrogen-rich gas. For example, with methane, the reaction is:
CH₄+H₂O [symbol] CO+3H₂ ΔH=−206.16 kJ/mol CH₄
CH₄+½O₂→CO+2H₂ ΔH=+36 MJ/kmol CH₄

With the appropriate mixture of input fuel, air and steam, the partial oxidation reaction supplies all the heat needed to drive the catalytic steam reforming reaction. Unlike a steam methane reformer, the autothermal reformer requires no external heat source and no indirect heat exchangers.

There exists a need in the art for high performance energy systems. In particular, an improved power system employing an electrochemical converter that employs structure to increase operational efficiency while concomitantly lowering costs by reducing the number of components would represent a major improvement in the industry.

### SUMMARY OF THE INVENTION

The present invention provides for a hydrogen and electricity co-production (HECP) system for producing hydrogen, electricity, or a combination of both hydrogen and electricity. Specifically, the invention provides for using an electrochemical converter, such as a fuel cell, to perform multiple functions, such as reforming fuel to produce hydrogen, consuming reactants to produce electricity, or performing a combination of both, depending upon the condition of an electrical load, such as a variable electrical load, that is attached to the fuel cell.

In a typical electricity-generating mode, the fuel cell performs an electrochemical reaction by reacting a hydrogen-containing fuel with oxygen to produce electricity, water and heat. In an alternative or reformer mode, the fuel cell can be adapted to utilize heat released by an electrochemical reaction of the fuel cell to reform a hydrocarbon fuel to produce hydrogen. Furthermore, in a co-production mode, both hydrogen and electricity are co-produced by the fuel cell. The HECP system can control an amount of hydrogen and/or electricity produced and can switch between modes by varying, adjusting or controlling an electric load on the system.

According to the teachings of the present invention, a co-production energy supply system capable of producing hydrogen and electricity is contemplated. The system includes a variable electric load for varying the amount of impedance on the system, and an electrochemical converter coupled to the variable electric load. During use, the electrochemical converter produces hydrogen, electricity or both responsive to the amount of impedance introduced to the system by the variable load.

The electrochemical converter can include a high temperature fuel cell, such as a solid oxide fuel cell or a molten carbonate fuel cell. The electrochemical converter can be constructed with an electrolyte plate having a fuel electrode material disposed on one side and an oxidant electrode material disposed on an opposite side. The electrolyte plate can include an oxygen-containing ion conducting plate, a hydrogen ion conducting plate, an OH ion conducting plate, or a CO₃ ion conducting plate.

According to the invention, the system can optionally include structure or means for introducing a fuel reactant and an oxidant reactant to the electrochemical converter.

According to one aspect, the variable load can be set to substantially zero to form a short-circuit across the electrodes such that no electric power is generated and oxygen-containing molecules are transported across said electrolyte plate to react with input fuel reactant to produce steam and heat, with which the remaining unspent input fuel reactant is formed into a hydrogen rich reformate, said electrochemical converter thereby functioning as a reformer.

According to another aspect, during use, oxygen-containing molecules from the input oxidant reactant can be transported across the electrolyte plate to react with the input fuel reactant with premixed steam at the fuel electrode to reform the input fuel reactant into a hydrogen rich reformate. When this occurs, the electrochemical converter functions as an autothermal reformer. Alternatively, during use, oxygen-containing molecules of the oxidant reactant can be transported across the electrolyte plate to react with the input fuel reactant without premixed steam at the fuel electrode to reform the input fuel reactant into a hydrogen rich reformate. When this occurs, the electrochemical converter functions as a partial oxidation reformer.

According to still another aspect, during use, air or relatively pure oxygen, and an input fuel reactant can be introduced to the electrochemical converter. The electrochemical converter allows oxygen-containing molecules are transported across the electrolyte plate to react with the input fuel reactant at the fuel electrode and generates heat to reform the remaining unspent input fuel reactant into a nitrogen free reformate.

According to still another aspect, the impedance of the variable electric load can be varied to vary the relative amount of or the ratio of electricity and hydrogen generated by the electrochemical converter.

During operation of the system, the variable load can introduce to the system at least a minimum impedance amount. When this occurs, the electrochemical converter reforms, primarily and only, an input fuel reactant into a hydrogen rich reformate. The minimum impedance amount can be about zero, and corresponds to a short circuit electrical arrangement across the electrochemical converter. Optionally, the variable load is adapted to introduce to the system a maximum impedance amount greater than the minimum impedance amount and which corresponds to an open circuit electrical arrangement across the electrochemical converter, in which no hydrogen or electricity is produced.

Optionally, the variable load can be adapted to introduce to the system an impedance amount that is between the maximum impedance amount and the minimum impedance amount so that the electrochemical converter produces both hydrogen and electricity. The relative amounts of the hydrogen and electricity produced by the electrochemical converter correspond to the amount of impedance introduced to the system by the variable load.

According to another aspect, the system can include structure or means for varying the impedance of the variable load so as to control the relative amount of hydrogen and electricity produced by the electrochemical converter. The means for varying can include a controller coupled to the variable load, the electrochemical converter, or both. The controller varies the amount of impedance of the variable load to control the relative amount of hydrogen and electricity produced by the electrochemical converter. Optionally, the controller can operate one or more fluid regulating devices for regulating the flow of one or more input reactants to the electrochemical converter to control the overall amount of hydrogen and/or electricity produced thereby.

The present invention also contemplates a method of co-producing hydrogen and electricity, that comprises the steps of providing a variable load for varying the amount of impedance on a system, providing an electrochemical converter capable of producing both hydrogen and electricity, and varying the impedance of the variable load to vary the relative amount of hydrogen and electricity generated by the electrochemical converter.

According to one aspect, the method can include the additional step of configuring the variable load to be able to introduce, in a reformer operational mode, at least a minimum impedance amount, where the electrochemical converter is adapted to reform, primarily and only, any unspent input fuel reactant into hydrogen when the variable load is set to the minimum impedance amount. The minimum impedance amount can be about zero, and which corresponds to a short circuit electrical arrangement.

According to another aspect, the variable load can be configured to be set to a maximum impedance amount greater than a minimum impedance amount, and which corresponds to an open circuit electrical arrangement across the electrochemical converter.

According to still another aspect, the method includes the step of configuring the variable load to be able to introduce, in a co-production operational mode, an impedance amount that is between the maximum impedance amount and the minimum impedance amount so that the electrochemical converter produces both hydrogen and electricity, where the amounts of the hydrogen and electricity produced by the electrochemical converter correspond to the amount of impedance of the variable load.

The present invention also contemplates an additional method of co-producing hydrogen and electricity, comprising the steps of performing an electrochemical reaction using a fuel cell to produce electricity; supplying heat generated by said electrochemical reaction to an electrode surface of the fuel cell, and performing a reforming process on a fuel supplied to the fuel cell using the heat generated by said electrochemical reaction.

The present invention further contemplates a method of co-producing electricity and hydrogen, comprising the steps of providing a fuel cell capable of operating in a fuel cell mode to produce electricity through an electrochemical reaction, in a reformer mode to produce hydrogen rich gas by reforming an input fuel, and in a co-production mode to produce both electricity and hydrogen, and varying the impedance of a variable load to vary the amount of at least one of hydrogen and electricity generated by the fuel cell.

The present invention further contemplates a method of producing hydrogen, comprising providing a fuel cell, providing a variable load, wherein the variable load is coupled to the fuel cell, and varying the impedance of the variable load to be substantially zero so that the fuel cell functions as a reformer to produce primarily and only hydrogen.

The present invention still further contemplates a method comprising the steps of reforming a fuel to produce hydrogen using a fuel cell; and simultaneously producing electricity using the same fuel cell.

The present invention still yet further contemplates a method, comprising the steps of co-producing electricity and hydrogen using a fuel cell, and varying a ratio of electricity to hydrogen produced by the fuel cell with a variable electric load.

### BRIEF DESCRIPTION OF THE FIGURES

The foregoing and other objects, features and advantages of the invention will be apparent from the following description and apparent from the accompanying drawings, in which like reference characters refer to the same parts throughout the different views. The drawings illustrate principles of the invention.

FIG. 1 is a schematic block diagram of one embodiment of a hydrogen and electricity co-production (HECP) system capable of operating in one of a plurality of modes to produce hydrogen and/or electricity.

FIGS. 2A-2C are exemplary graphical illustrations of the various operational modes of a cell of the electrochemical converter of the HECP system of FIG. 1.

FIG. 3 illustrates an energy mapping of a hydrogen and electricity co-production process according to an illustrative embodiment of the invention.

FIG. 4 illustrates a power map of a hydrogen and electricity co-production process according to an illustrative embodiment of the invention.

### DETAILED DESCRIPTION OF THE INVENTION

The present invention provides a hydrogen and electricity co-production (HECP) system that is efficient, cost-effective and flexible. The invention will be described below relative to illustrative embodiments. Those skilled in the art will appreciate that the present invention may be implemented in a number of different applications and embodiments and is not specifically limited in its application to the particular embodiment depicted herein.

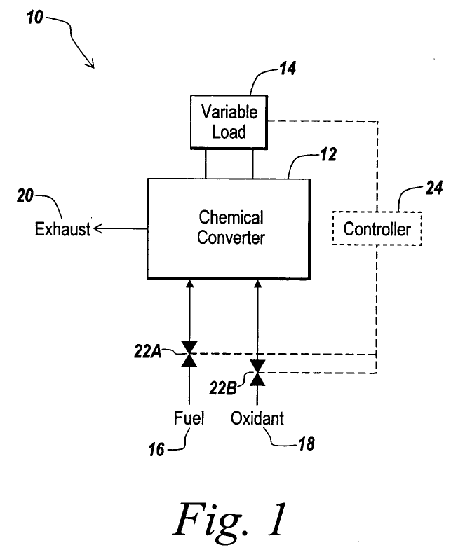

FIG. 1 shows an embodiment of a hydrogen and electricity co-production (HECP) system 10 suitable for producing hydrogen, electricity, or a combination of both hydrogen and electricity. The HECP system 10 comprises an electrochemical converter 12 that is coupled to a variable electric load 14. The electrochemical converter 12 is adapted to receive input reactants, such as a fuel 16 and an oxidant 18. The electrochemical converter 12 can be operated in a number of select modes to produce an exhaust or hydrogen-rich gas 20 from the input reactants 16 and 18. The illustrated HECP system 10 can optionally include one or more fluid regulating devices 22A or 22B, such as valves, for controlling one or more of the fuel and oxidant reactants 16, 18 being introduced to the electrochemical converter. The HECP system 10 can also optionally include a controller 24 for controlling one or more of the fluid regulating devices 22A, 22B, the variable load 14 to be incorporated with the electrochemical converter 12, and if desired the electrochemical converter. The input fuel reactant can be any suitable hydrocarbon fuel known to those of ordinary skill in the art. The input oxidant reactant can comprise any suitable oxygen-containing fluid. The electrochemical converter 12 can be any suitable device, and is preferably a high temperature fuel cell, such as a solid oxide or a molten carbonate fuel cell. Those of ordinary skill will readily recognize that the electrochemical converter 12 of the present invention can employ one or more fuel cells, as well as additional equipment, such as heat regulating devices, enclosures, and the like for safe and efficient operation of the system. For the sake of simplicity, we describe and illustrate the system 10 below as employing a fuel cell and omit for clarity other additional equipment. The illustrated fuel cell has in-situ autothermal reforming (ATR) or partial oxidation reforming (POX) capabilities, which allows direct field operation and control that enables selection of a co-production ratio between the level of electricity generated and the amount of hydrogen produced.

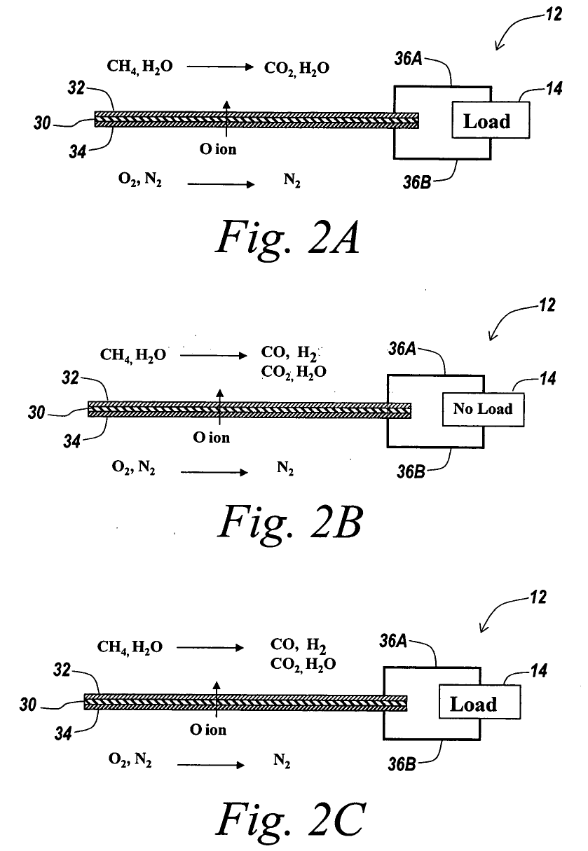

As illustrated in FIGS. 2A through 2C, the illustrated fuel cell 12 has a basic fuel cell unit design that employs an electrolyte plate 30 that has a fuel electrode layer 32 on one side and an oxidizer electrode layer 34 on the opposite side, to form an electrolyte/electrodes assembly. The electronic conductive electrode layers form fuel and oxidizer electrodes attached to opposite sides of the ionic conductive electrolyte. The electrolyte plate 30 comprises an oxygen-containing ion conducting plate, a hydrogen ion conducting plate, an OH ion conducting plate, or a CO₃ ion conducting plate.

The unit cell of the fuel cell 12 also employs interconnector plates that are interleaved between adjacent electrode layers. The interconnectors are preferably made of an electrically and thermally conductive interconnect material. The interconnector plate can serve as the electrical connector between adjacent electrodes and as a partition between the fuel and oxidizer reactants. A fuel manifold and an oxidizer manifold are also provided to provide reactants, namely fuel and oxidizer, respectively, to each of the unit cells in the fuel cell 12. Depending upon the mode of operation, the fuel cell 12 emits resultants, the spent fuel and the spent oxidizer, to respective exhaust manifolds. Electrical connectors 36A and 36B are provided for connecting the fuel cell 12 to the external electrical load 14.

An example of a fuel cell module suitable for use with the present invention is described in U.S. Pat. Nos. 5,462,817, 5,338,622, 5,501,781, 5993,201, 5,833,822, and 5,747,185, to the inventor hereof, the contents of which are herein incorporated by reference. The illustrated fuel cell 12 exhibits excellent system scalability, power density, thermal stability and structural ruggedness than other technologies. The fuel cell 12 is further capable of operating at high operating temperatures, for example, between 600° C. and about 1000° C. While the fuel cell 12 generally requires initial external heating at startup, the electrochemical reaction is exothermic in nature, and can produce high-grade heat to drive hydrogen co-production or bottoming cycle plants, as described below. Typically, the byproduct heat from the fuel cell 12 can exceed 50% of the lower heating value of the fuel inputs.

Those of ordinary skill will readily recognize that the HECP system 10 can comprise any suitable electrochemical converter capable of producing electricity and/or hydrogen rich gas, such as a molten carbonate fuel cell and preferably a solid oxide fuel cell.

The illustrated HECP system 10 is a multi-function system. In addition to the traditional function of electrical generation, the fuel cell 12 can be utilized to perform reforming for hydrogen production or the co-production of hydrogen and electricity. In a traditional mode of operation, the fuel cell 12 generates electricity by electrochemically reacting the input fuel reactant with the input oxidant reactant to generate power, waste heat and exhaust, which includes carbon dioxide and water. In an alternative mode of reformer operation, the fuel cell 12 reforms the input fuel reactant to generate a hydrogen exhaust without simultaneously generating electricity. Additionally reactant by-products that can be included in the exhaust include carbon monoxide, carbon dioxide, and water. In a combined or co-production mode of operation, the fuel cell 12 simultaneously generates both a hydrogen exhaust, through reforming of a hydrocarbon fuel, and electricity. The exhaust can include additional reaction species such as carbon monoxide, carbon dioxide and water.

As used herein, the term “reforming” and the like refers to a chemical process performed by the fuel cell 12 that reacts hydrocarbon fuels, at an elevated temperature, such as above 250° C., and preferably between about 400° C. and about 1000° C., in the presence of steam, oxygen or both, to generate a hydrogen-rich fuel exhaust. In the present invention, the fuel cell 12 reforms hydrocarbon fuels to produce hydrogen by reacting the hydrocarbon fuel with water, and optionally oxygen, and high-grade heat.

The fuel cell 12 can switch among the different operational modes, generate electricity, produce hydrogen or vary the ratio of hydrogen to electricity produced in the combined mode, by controlling the amount of load by way of the variable load 14 that is applied to the fuel cell 12 through the electrical connectors 36A and 36B. For example, when one or more unit cells of the fuel cell 12 are arranged or placed in a short circuit electrical configuration (i.e., short-circuited), such as by varying, controlling, regulating or placing the electrical resistance or impedance of the variable load 14 to be approximately zero with the controller 24, and electric power is neither generated nor received thereby, the fuel cell operates essentially as a reformer (a simple oxygen transport membrane). If the variable load is configured to apply a non-short-circuited impedance load to the electrochemical converter, then the converter generates both hydrogen and electricity, the relative amounts of which depend upon the load impedance value. Those of ordinary skill will readily recognize that if a maximum load is applied to the fuel cell 12, such as an open circuit electrical configuration, then the fuel cell generates no electricity or hydrogen. A load amount between the maximum (open-circuit) and minimum (short-circuit) amounts, can hence be applied to the fuel cell 12 to regulate, control or vary the amount of electricity and hydrogen generated or produced by the fuel cell 12. For the sake of simplicity, hereinafter we will refer to the load 14 as a variable load, will describe the load as introducing an impedance, will describe the load or other system component as varying the impedance, and will describe the controller 24 as varying the impedance of the load.

The fuel cell 12 can alternatively operate in a “reverse” mode to produce hydrogen by splitting water. In this mode, the unit cells can function as an electrolyzer when external power is applied. The electricity used to produce hydrogen in the reverse mode can be derived from renewable energy, such as windmills, solar cells and hydropower. The use of a high-temperature SOFC as a high temperature electrolyzer is more efficient than lower temperature alkaline or proton exchange membrane (PEM) technologies, because the electrical input requirements for the electrolytic reaction at high temperature is displaced up to 30% by thermal energy according to Nernst potential. Thermal energy is a lower cost energy source than electricity by a factor of at least three or more.

With reference to FIGS. 1 and 2A, the present invention can preserve the capability of the fuel cell 12 to be operated in an electricity generating mode. The fuel cell 12 functions as an electrochemical converter to react the input fuel reactant, such as hydrogen, with oxygen to produce primarily and only electricity. The fuel cell 12 can optionally consume internally reformed hydrogen rich gas in this mode without the burdens or costs associated with additional hydrogen purification and cooling steps. The fuel cell impedance amount presented or introduced to the system can be any suitable impedance value sufficient to enable the converter to produce substantially, primarily and only electricity, with no or nominal amounts of hydrogen generation occurring.

As shown, the electrical connectors 36A and 36B connect the variable load 14 to the fuel cell 12. The variable load introduces to the system an impedance amount greater than the minimum impedance amount (short-circuit) and less than the maximum impedance amount (open-circuit) to enable the converter to produce electricity. This impedance amount presented or introduced to the system can be any suitable impedance value sufficient to enable the converter to produce substantially, primarily, and only electricity with no or nominal amounts of reforming occurring (e.g., hydrogen generation). As is known to those of ordinary skill, when the variable load is set to either open-circuit or short-circuit, the electrochemical converter does not generate any electricity.

The variable load is electrically connected across at least a portion of the electrochemical converter, such as between the fuel and oxidizer electrodes. A fuel gas illustrated as a hydrocarbon fuel CH₄ is supplied to a fuel electrode 32 on a first side of the oxygen-containing ion conducting electrolyte plate 30, while oxygen and nitrogen are supplied to the oxidizer electrode 34 on the second side of the electrolyte plate 30. The oxidizer electrode (cathode electrode) 34 ionizes the oxygen to form negatively charged ions. The oxygen-containing ions pass through the oxygen-containing ion conducting electrolyte plate 30 to the fuel (anode) electrode and react with the ionized hydrogen to produce carbon dioxide, water and electrons. The electrons flow through the electrical connectors 36A and 36B to power the load 14. The electrochemical reaction is an exothermic reaction that also produces heat. The water in the form of steam exits the stack as part of the exhaust or as condensed steam, and the carbon dioxide can be collected or sequestered to prevent greenhouse gas emissions if desired.

The fuel gas can comprise any suitable fuel containing hydrogen, including, but not limited, to pure hydrogen, natural gas, hydrocarbon fuels and coal.

With reference to FIGS. 1 and 2B, the fuel cell 12 can be operated in a reformer mode, for reforming a hydrocarbon fuel to produce hydrogen. In the system of the present invention, the variable load is adapted to introduce thereto at least a minimum impedance amount where the electrochemical converter is adapted to reform an input fuel reactant into primarily and only hydrogen when excess fuel (e.g., any remaining unspent fuel beyond the electrochemical reaction of the fuel cell) is provided to the converter and the variable load is set to the minimum impedance amount. That is, the fuel cell can reform that amount of fuel provided to the fuel cell that is above the fuel amount employed for operating the electrochemical reaction of the fuel cell. The minimum impedance amount presented or introduced to the system can be any suitable impedance value low enough to enable the converter to produce substantially, primarily and only hydrogen, with no or nominal amounts of electricity generation occurring. According to one practice, in this reforming mode, the external electric load is reduced to generally or substantially about zero, which represents a short circuit condition to the fuel cell. The short circuit results in zero electrical power produced by the converter while maintaining a high current flow through the external contacts and a high flux of oxygen-containing ions conducted through the electrolyte ready to react with the fuel species on the fuel electrode surfaces of the cell units. The remaining unspent fuel undergoes reforming reaction with the simultaneous presence of water or oxygen at a proper temperature, and heat supplied by the short circuit electrochemical reaction. The operation condition can be controlled by the controller 24 according to the conservation of chemical species, first and second laws of thermodynamics as well as thermal and electrochemical principles. Hence, it is evident to the skilled artisan from the teachings herein that the fuel amount introduced to the fuel cell can be regulated in order to regulate the amount of hydrogen produced by the fuel cell.

In the fuel cell electrochemical process, the Gibb's free energy provides the electrical energy output of the fuel cell and the balance enthalpy energy provides heat for the reforming process. The present inventor has realized that if the electric energy output is kept to zero by shorting the fuel cell or stack, the total enthalpy is available for the reforming process. This latter scenario is equivalent to the conventional autothermal or partial oxidation reformer or the membrane reformer process with the advantage of performing autothermal reforming with O₂ alone without the encumbrance of N₂ derived from the air supply. In this condition, oxygen-containing ions conducted through the oxygen-containing ion conducting electrolyte plate 30 immediately react with the fuel to form water and CO₂ molecules, which in turn further promote reforming of the remaining fuel. The oxygen-containing ions arrival at the fuel electrode surface 32 together with heat generated by reacting with the fuel species constitute the basis for autothermal reforming of the remaining fuel species with pre-mixed steam. Oxygen mixing with unreacted fuel species without externally provided steam or water serves as the basis for partial oxidation reforming when mixing with pure fuel species.

In the reforming mode, any suitable hydrocarbon or renewable fuel may be used. The reforming mode also produces carbon dioxide, which may be easily captured for sequestration. Nitrogen, present in air, passes unreacted through the fuel cell 12 and can be released to the atmosphere. An advantage of the illustrative reforming method is that the carbon dioxide off-gas can be collected separately from the nitrogen, in contrast to conventional autothermal reformers, in which the effluent has nitrogen and carbon dioxide co-mingled.

In the reformer mode, the fuel cell 12 requires heightened thermal robustness to handle the extra thermal load which otherwise would be exported as electricity if the stack is used for power generation. The HECP system 10 of the present invention offers particular advantages and flexibility to facilitate reforming in addition to electricity production. For example, the fuel cell 12 has a relatively small reactant flow gap that allows for effective heat transfer from the heated electrode/electrolyte surface to the reactant bulk. The small reactant flow gap further allows effective heat transfer from electrode/electrolyte surface to the opposing interconnector plate. The illustrated fuel cell 12 further utilizes a highly conductive interconnector that prevents the formation of hot spots in the stack, efficiently transmits heated stream toward the inlet of the incoming reactants to provide preheating of the reactants, and efficiently transmits heat outward of the stack for radiation cooling.

With reference to FIGS. 1 and 2C, both electricity and hydrogen can be generated in accordance with a co-production mode, by controlling the amount of impedance introduced to the system by the electrical load. The variable load is adapted to introduce to the system an impedance amount that is greater than the minimum impedance amount but less than the maximum impedance amount to generate both hydrogen and electricity. The amounts of hydrogen and electricity produced by the electrochemical converter correspond to the amount of impedance introduced to the system by the variable load. As the output of the HECP system 10 is controlled according to the amount of the load impedance of the variable load 14 applied to the system, the ratio of electrical output to hydrogen output (e.g., reforming quantity) can be varied or regulated. This operation constitutes an ultimate form of hydrogen electric co-production (HECP) since it can be controlled according to system requirements. The amount of electricity generated by the fuel cell 12 or the amount of fuel reformed can be controlled, regulated, or varied by adjusting the amount of current extracted from the fuel cell 12 by controlling the electrical load.

In the present invention, the ratio of electrical to hydrogen outputs can be regulated through load impedance and oxidant to fuel reactant proportioning. The controller 24 can regulate one or more of the fluid regulating devices to vary or regulate the amount of the input reactants introduced to the fuel cell 12. This regulation scheme provides an additional degree of control over the system 10, and can be used separately from or in conjunction with the foregoing control schemes (i.e., controlling the variable load 14) to vary the amount of system production. The flexibility of the HECP system 10 benefits capacity utilization as it performs electrical generation and hydrogen reforming with a single fuel cell 12.

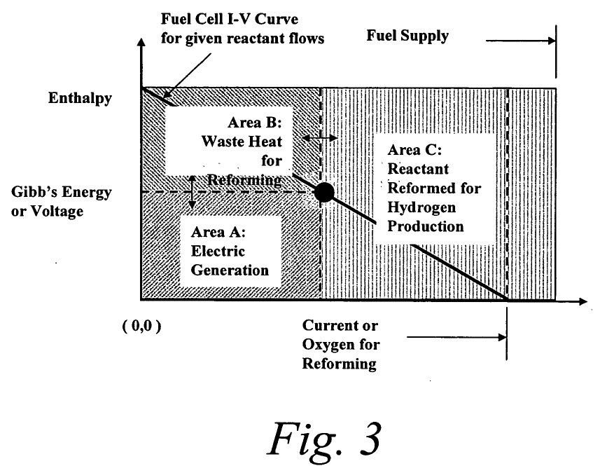

Further explanation of the multi-mode HECP system 10 is given as an extension to the fuel cell operation. As in the energy mapping given in FIG. 3, the dot “•” in the graph represents the fuel cell operation condition with a given voltage and current and can move along the fuel cell I-V curve. Subsequently, Area A represents the energy output from the fuel cell. Area B is the waste heat available in the fuel cell. Area C is the portion of reactant available to undergo reforming for hydrogen production. As the fuel cell operation moves along the I-V curve, the electric output and the amount of fuel reforming changes complementarily. The amount of waste heat available from the fuel cell operation and amount of oxygen-containing molecules or the current flow are coordinated to meet the mass and energy balance of the reforming process with a given set of total oxygen supply and total fuel supply as represented by the horizontal axis.

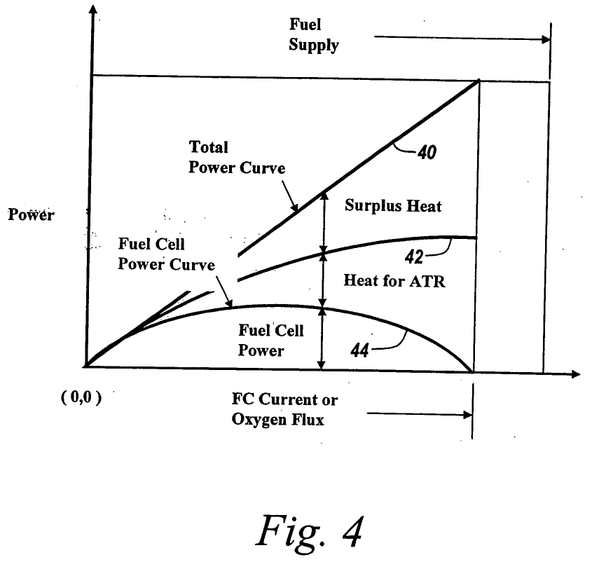

As shown in FIG. 4, the ratio or power generation and hydrogen generation can be viewed from the illustrated power map, where the ratio of the quantity of fuel cell power and the quantity of heat available for reforming can vary over the range of current flow or oxygen flux. The preferred range of operation is from 100% oxygen flux operation for hydrogen production to 40% oxygen flux operation for typical high efficiency power generation. As illustrated at the right side of the graph, during the reformer operational mode, where the variable load introduces a minimum impedance value or amount (e.g., short circuit) to the fuel cell, the impedance value is essentially zero while the fuel cell delivers a maximum current and minimum voltage. In this operational mode, the fuel cell functions as a reformer and hence reforms the excess or remaining unspent fuel reactant to produce hydrogen, as described above. As illustrated at the left side of the graph, when the variable load is set to be a maximum impedance value or amount (e.g., open circuit), there is zero current and maximum voltage produced by the fuel cell. In this operational mode, the system 10 does not generate any hydrogen or electricity.

The present inventor has realized that between the minimum and maximum impedance values, the system 10 generates a varied and non-linear ratio of hydrogen to electricity as a direct function of the amount of impedance introduced to the system. For example, as illustrated by the reformer power curve 42, the fuel cell functions primarily as a reformer with increased production as the current increases to a maximum and the impedance level is essentially zero. However, as illustrated by the fuel cell power curve 44, the fuel cell 12 can function as an electricity generator with a maximum capacity at an optimal impedance value between the open-circuit mode and the short circuit mode since the electric power generation equates the product of the current and the voltage of the electrochemical device.

The elegant thermal management design and operation of the HECP system 10, advanced structured stack architecture, and heat “precuperation” provide for a highly efficient, compact and productive distributed generation plant. The electrical output of the fuel cell 12 can be best utilized by compression equipment in aid of the storage scheme for hydrogen produced using the fuel cell. The co-production capability provides a self-contained energy solution to the currently emerging hydrogen infrastructure needs. The present invention increases space efficiency allowing for a more competitive distributed generation alternative.

The illustrated HECP system 10 can alternatively include an additional tri-generation option through incorporation of an absorption chiller, water heater/boilers, microturbine or other bottoming cycle plants that can further boost the overall system efficiency and utility appeals. The respective efficiency values of the various foregoing modes are as follows:

| | |
|---|---|
| a. Hydrogen & Electricity | 120% reforming efficiency with |
| Co-Production | fuel cell waste heat utilization |
| | 40% electrical efficiency |
| | 70% co-production efficiency |
| b. Hydrogen Production | 80% reforming efficiency |
| c. Electricity Fuel Cell/Microturbine | 57% electrical efficiency |

The multi-function capability of the HECP system 10 is particularly attractive for renewable power parks and distributed generation applications. In the solid oxide electrolyzer/fuel cell modes the HECP system 10 can offer higher efficiency relative to its low temperature counterparts, resulting from reduced Nernst potential for electrolysis operation and co-generation or co-production synergies using the waste heat of the high temperature fuel cell operation. The versatility of the multi-mode functionality can allow for full capacity utilization by adapting the operation to varying business cases such as a prioritized scheme to exploit low cost renewable energy, high hydrogen demand or electric peak-shaving. Moreover, the consolidated hardware as described will be more capital and operationally efficient than combining several discrete systems to achieve the same purpose and capabilities. Due to these advantages, the HECP system 10 is envisioned to provide an exceedingly lower cost and higher capital utilization pathway toward the nation's hydrogen and energy objectives.

The combined benefits of this hybrid concept include, but are not limited to, efficiency and cost. The endothermic reforming process utilizes significant energy made available from the high grade heat discharged from the high temperature fuel cell process, resulting in greater efficiency. The ability to vary the reforming capabilities and electricity production of the fuel cell 12 avoids the need for transport of hot flows and external heat exchangers. In addition to the mode specific benefits, the multi-mode HECP system 10 can be operated at a high utilization rate. In the absences of renewable energy supply or hydrogen gas, the fuel cell 12 can continue to operate as a hydrocarbon fuel cell for power generation or as an equivalent membrane reformer for hydrogen production, or both to varying degrees. The HECP system 10, offering durable operation and full capacity utilization, is capable of achieving $0.04/kWh of electrical generation or $1.50/kg of hydrogen production.

The HECP system 10 of the present invention performs hydrogen electric co-production by directly applying within the fuel cell stack the waste heat generated by the fuel cell itself so as to provide the necessary heat for enabling the stack to reform an input fuel reactant. The system of the present invention hence uses a single fuel cell stack to function as both an electricity generating device and a reformer to achieve enhanced efficiency over systems that employ separate fuel cells and reformers. The efficiency of the illustrated system approaches the combined efficiencies of the separately operated devices.

Those of ordinary skill will readily recognize that any selected number and arrangement of electrochemical converters can be employed in the system 10 of the present invention, provided that the electrochemical converters have the capability to operate as both an electricity generating device and a reformer. During use, the electrochemical convert can operate at relatively full capacity while generating electricity, hydrogen, or both.

A significant advantage of the present invention is that the electrochemical converter of the system 10 of the present invention can be operated to satisfy peak electrical demands of the system while concomitantly utilizing any excess capacity for hydrogen production. As the hydrogen generator, the HECP system 10 offers nitrogen-free reformate for high-quality hydrogen production. The system also produces pure carbon dioxide exhaust for ease of this greenhouse gas sequestration.

It will thus be seen that the invention efficiently attains the objects set forth above, among those made apparent from the preceding description. Since certain changes may be made in the above constructions without departing from the scope of the invention, it is intended that all matter contained in the above description or shown in the accompanying drawings be interpreted as illustrative and not in a limiting sense.

It is also to be understood that the following claims are to cover generic and specific features of the invention described herein, and all statements of the scope of the invention which, as a matter of language, might be said to fall therebetween.

1. A co-production energy supply system capable of producing hydrogen and electricity, comprising
a variable electric load for varying the amount of impedance on the system, and
an electrochemical converter coupled to the variable electric load,
wherein said electrochemical converter produces at least one of hydrogen and electricity responsive to the amount of the impedance introduced to the system by said variable load.

2. The system of claim 1, wherein said electrochemical converter is a high temperature fuel cell comprising at least one of a solid oxide fuel cell and a molten carbonate fuel cell.

3. The system of claim 1, wherein said electrochemical converter comprises
an electrolyte plate,
a fuel electrode material disposed on one side of the electrolyte plate, and
an oxidant electrode material disposed on an opposite side of the electrolyte plate.

4. The system of claim 3, wherein the electrolyte plate comprises one of an oxygen-containing ion conducting plate, a hydrogen ion conducting plate, an OH ion conducting plate, and a CO₃ ion conducting plate.

5. The system of claim 1, further comprising means for introducing a fuel reactant and an oxidant reactant to the electrochemical converter.

6. The system of claim 3, wherein an input fuel reactant is introduced to the electrochemical converter and is distributed to the fuel electrode, and an input oxidant reactant is introduced to the electrochemical converter and is distributed to the oxidant electrode, and wherein the electrochemical converter produces spent fuel and spent oxidant.

7. The system of claim 6, wherein the electrochemical converter is adapted to produce the spent fuel as a result of an electrochemical reaction between the fuel reactant and the oxidant reactant that is ionically transported through the electrolyte plate.

8. The system of claim 7, wherein the electrochemical reaction generates a voltage across the electrodes and a current flows from the oxidant electrode to the fuel electrode through the external variable load.

9. The system of claim 7, wherein the electrochemical reaction generates heat according to electrochemical laws.

10. The system of claim 3, wherein the variable load is adapted to be set to substantially zero to form a short-circuit across the electrodes such that no electric power is generated, said electrochemical converter thereby functioning as a reformer to reform any unspent input fuel reactant into a hydrogen rich reformate.

11. The system of claim 3, wherein the variable load is adapted to be set to substantially zero to form a short-circuit across the electrodes such that no electric power is generated and oxygen-containing molecules are transported across said electrolyte plate to react with input fuel reactant to form a hydrogen rich reformate, said electrochemical converter thereby functioning as a reformer to reform any remaining unspent input fuel reactant above the amount employed for operating the electrochemical reaction within the electrochemical converter.

12. The system of claim 9, wherein, during use, oxygen-containing molecules from said input oxidant reactant are transported across said electrolyte plate to react with the input fuel reactant mixture with steam at the fuel electrode to reform the input fuel reactant into a hydrogen rich reformate, said electrochemical converter thus functioning as an autothermal reformer.

13. The system of claim 9, wherein, during use, oxygen-containing molecules of said oxidant reactant are transported across said electrolyte plate to react with the input fuel reactant at the fuel electrode to reform the input fuel reactant into a hydrogen rich reformate, said electrochemical converter thus functioning as a partial oxidation reformer.

14. The system of claim 3, wherein, during use, air or relatively pure oxygen, and an input fuel reactant are introduced to the electrochemical converter, wherein said electrochemical converter generates heat and oxygen-containing molecules are transported across said electrolyte plate to react with the input fuel reactant at the fuel electrode to reform the input fuel reactant into a nitrogen free reformate.

15. The system of claim 1, wherein said impedance of said variable load can be varied to vary the relative amount of or the ratio of electricity and hydrogen generated by said electrochemical converter.

16. The system of claim 1, wherein the electrochemical converter is adapted to be operated in an electrolyzer mode to produce hydrogen from an input reactant when electricity, in lieu of a load, is supplied to the electrochemical converter.

17. The system of claim 16, wherein the electricity introduced to the electrochemical converter is supplied by renewable energy sources, said renewable energy sources including at least one of wind power, solar power, and hydropower.

18. The system of claim 1, wherein said variable load is adapted to introduce to the system at least a minimum impedance amount, and wherein said electrochemical converter is adapted to reform, primarily and only, an input fuel reactant into a hydrogen rich reformate when said variable load is set to said minimum impedance amount.

19. The system of claim 18, wherein said minimum impedance amount is about zero.

20. The system of claim 18, wherein said minimum impedance amount corresponds to a short circuit electrical arrangement across said electrochemical converter.

21. The system of claim 20, wherein said variable load is adapted to introduce to the system a maximum impedance amount greater than the minimum impedance amount and which corresponds to an open circuit electrical arrangement across said electrochemical converter.

22. The system of claim 21, wherein said variable load is adapted to introduce to the system an impedance amount that is between said maximum impedance amount and said minimum impedance amount so that said electrochemical converter produces both hydrogen and electricity, wherein said relative amounts of said hydrogen and electricity produced by said electrochemical converter correspond to said amount of impedance introduced to the system by said variable load.

23. The system of claim 1, further comprising means for varying said impedance of said variable load so as to control the relative amount of hydrogen and electricity produced by said electrochemical converter.

24. The system of claim 23, wherein said means for varying comprises a controller coupled to at least one of said variable load and said electrochemical converter.

25. The system of claim 1, further comprising a controller coupled to at least one of said electrochemical converter and said variable load for controlling a parameter of said system.

26. The system of claim 25, wherein said controller varies the amount of impedance of said variable load to control the relative amount of hydrogen and electricity produced by the electrochemical converter.

27. The system of claim 25, wherein said controller operates one or more fluid regulating devices for regulating the flow of one or more input reactants to said electrochemical converter to control the overall amount of hydrogen and/or electricity produced thereby.

28. A method of co-producing hydrogen and electricity, comprising
providing a variable load for varying the amount of impedance on a system,
providing an electrochemical converter capable of producing both hydrogen and electricity, and
varying the impedance of the variable load to vary the relative amount of hydrogen and electricity generated by said electrochemical converter.

29. The method of claim 28, wherein said electrochemical converter is a high temperature device including at least one of a solid oxide fuel cell and a molten carbonate fuel cell.

30. The method of claim 28, further comprising introducing a fuel reactant and an oxidant reactant to the electrochemical converter.

31. The method of claim 28, wherein the electrochemical converter comprises an electrolyte plate having a fuel electrode on one side and an oxidant electrode on the other side, further comprising setting the variable load to be substantially zero to form a short-circuit across the electrodes such that no electricity is generated, said electrochemical converter thereby functioning as a reformer to reform any remaining unspent input fuel reactant into a hydrogen rich reformate.

32. The method of claim 28, further comprising operating said electrochemical converter as one of an autothermal reformer and a partial oxidation reformer.

33. The method of claim 28, further comprising operating said electrochemical converter in an electrolyzer mode to produce hydrogen from an input reactant when electricity, in lieu of a load, is supplied to the electrochemical converter.

34. The method of claim 28, further comprising configuring said variable load to be able to introduce, in a reformer operational mode, at least a minimum impedance amount, wherein said electrochemical converter is adapted to reform, primarily and only, any remaining unspent input fuel reactant into hydrogen when said variable load is set to said minimum impedance amount.

35. The method of claim 34, wherein said minimum impedance amount is about zero.

36. The method of claim 34, wherein said minimum impedance amount corresponds to a short circuit electrical arrangement across at least a portion of said electrochemical converter.

37. The method of claim 28, wherein said variable load is configured to be set to a maximum impedance amount greater than a minimum impedance amount, and which corresponds to an open circuit electrical arrangement across said electrochemical converter.

38. The method of claim 37, further comprising configuring said variable load to be able to introduce, in a co-production operational mode, an impedance amount that is between said maximum impedance amount and said minimum impedance amount so that said electrochemical converter produces both hydrogen and electricity, wherein said amounts of said hydrogen and electricity produced by said electrochemical converter correspond to said amount of impedance of said variable load.

39. The method of claim 28, further comprising regulating the flow of one or more input reactants to said electrochemical converter to control the overall amount of hydrogen or electricity production.

40. A method of co-producing hydrogen and electricity, comprising the steps of:
performing an electrochemical reaction using a fuel cell to produce electricity;
supplying heat generated by said electrochemical reaction to an electrode surface of the fuel cell; and
performing a reforming process on a fuel supplied to the fuel cell using the heat generated by said electrochemical reaction.

41. The method of claim 40, wherein the fuel cell comprises a high temperature fuel cell including at least one of a solid oxide fuel cell and a molten carbonate fuel cell.

42. The method of claim 40, further comprising the step of varying an impedance of an electrical load coupled to the fuel cell to vary a ratio of electricity to hydrogen produced by said fuel cell.

43. The method of claim 42, wherein the step of varying the electrical load comprises reducing the external electrical load to substantially zero to suspend electric power generation while continuing to produce hydrogen rich gas.

44. A method of co-producing electricity and hydrogen, comprising
providing a fuel cell capable of operating in a fuel cell mode to produce electricity through an electrochemical reaction, in a reformer mode to produce hydrogen rich gas by reforming an input fuel, and in a co-production mode to produce both electricity and hydrogen, and
varying the impedance of a variable load to vary the amount of at least one of hydrogen and electricity generated by the fuel cell.

45. A method of producing hydrogen, comprising
providing a fuel cell,
providing a variable load, wherein the variable load is coupled to the fuel cell, and
varying the impedance of the variable load to be substantially zero so that the fuel cell functions as a reformer to produce primarily and only hydrogen.

46. The method of claim 45, further comprising when operating the fuel cell as a reformer, producing nitrogen-free reformate for high-quality hydrogen production.

47. The method of claim 45, further comprising, when operating the fuel cell as a reformer, producing carbon dioxide exhaust, which is capable of sequestration.

48. A method, comprising the steps of
reforming a fuel to produce hydrogen using a fuel cell; and
simultaneously producing electricity using the same fuel cell.

49. The method of claim 48, further comprising, when operating the fuel cell as a reformer, producing nitrogen-free reformate for high-quality hydrogen production.

50. The method of claim 48, further comprising, when operating the fuel cell as a reformer, producing carbon dioxide exhaust, which is capable of sequestration.

51. A method, comprising the steps of:
co-producing electricity and hydrogen using a fuel cell; and
varying a ratio of electricity to hydrogen produced by the fuel cell with a variable electric load.

52. The method of claim 51, wherein the step of varying the ratio comprises varying an impedance value of the external electrical load applied to the fuel cell.

53. The method of claim 51, further comprising producing nitrogen-free reformate for high-quality hydrogen production.

54. The method of claim 51, further comprising producing carbon dioxide exhaust, which is capable of sequestration.
